(19) United States
(12) Patent Application Publication
(10) Pub. No.: US 2006/0054028 A1
(43) Pub. Date: Mar. 16, 2006

(54) Household pan with handles of the casserole type

(76) Inventor: Ines Goldstein De Pinchuk, Buenos Aires (AR)

Correspondence Address: ROGER PITT;KIRKPATRICK & LOCKHART NICHOLSON GRAHAM LLP, 599 LEXINGTON AVENUE, 33RD FLOOR, NEW YORK, NY, 10022-6030, US

(21) Appl. No.: 11/106,343

(22) Filed: Apr. 14, 2005

(30) Foreign Application Priority Data
Aug. 2, 2002 (AR) P 02 01 02952

(51) Int. Cl. A47J 37/12

(52) U.S. Cl. 99/403

(57) ABSTRACT

The pot has foldable handles in order to facilitate and save space in the kitchen cupboard. Each handle has two pieces made of folded steel, forming two ears which hold the joint of both pieces. The anchorage piece is riveted to the exterior part of the pot and the second piece which is movable, is formed by a metal sheet which acts as a handle. On its free rim a metal hoop that leans against it, is able to extend the handle, by snapping its free rim against a convexity formed by the anchorage piece. The facing rims of both pieces form the security device which permits to lift the pot.

### TECHNICAL FIELD

The present invention is to be used in household pans, which can be domestic, industrial or commercial, and is generally referred as pans or pots with handles of the type commonly used to warm up and cook solid foods or liquids. More especially the invention concerns a casserole whose handles can adopt a different position than the normal one, when stored.

### RECORD OF THE INVENTION

A kitchen generally has a set of pots of different sizes, which are not used during the greater part of the time, are stored on shelves and cupboards. Even though the cylindrical form of the container adapts well to the available spaces, its handles which project from the exterior side many times forces to increase the space which they occupy when stored moving away the kitchen tools or not facilitating the housewife's habit to shelter them, one into the other, taking advantage of the similarity of their forms and sizes.

### SUMMARY OF THE INVENTION

The aim of this invention is to reduce to its minimum, the space needed to store this type of casseroles without reducing their sizes nor the usefulness of the handles. Another aim is, that the construction of the handles should be strong, simple and economic and that it should be easy and more secure to use the pot in the kitchen. These and other aims and advantages which are shown ahead, can be reached by the construction of foldable handles built in two pieces, one for the anchorage of the handle to the exterior part of the pot and another foldable which conforms the handle itself and articulates with the anchored piece in two different positions: stretched out for its use and folded for its storage. The joint between both parts not only articulates, but also holds the foldable part in fixed position when stretched out.

A strong, as well as a simple way of manufacturing the handles, can be obtained with two pieces of folded steel, one of which forms the handle itself and articulates inside the other one which permits the anchorage to the pot. A metal hoop, which is less rigid than the other two parts, is fixed to the free rim of one of them. The other free end of the metal hoop, blocks against a convexity on the surface of the anchored piece in order to hold the handle extended. To unblock, push softly upwards.

### BRIEF DESCRIPTION OF THE DRAWINGS

It will be demonstrated the way in which these and other objectives and advantages of the invention are reached when put into practice more clearly, making reference to the detailed description which follows, as an example and in some restricted way of the preferred accomplishments of the invention, together with the drawings, in which:

FIG. 1 is a side view of a pot with the handle in the preferred accomplishment of the invention in stretched out or in use position;

FIG. 2 is a front view of the pot of FIG. 1 which shows one of the handles in withdrawn or storing position.

FIG. 3 is a development of the material used to obtain the anchorage piece for the handles of the preceding figures;

FIG. 4 is a diagram in ground plan of the piece of anchorage obtained with the material used in the preceding figure;

FIG. 5 is a cross section of the anchorage piece through plane V-V shown in FIG. 4;

FIG. 6 is a development of the material used to obtain the foldable part of the handle of FIGS. 1 and 2;

FIG. 7 is a diagram in ground plan of the foldable part obtained with the material used in the preceding figure;

FIG. 8 is a diagram in ground plan which shows the joint of FIGS. 4 and 7;

FIG. 9 is a side view of the handle built according to the preceding figure accomplishing the invention;

FIG. 10 is a view of the lower part of the handle of the preceding figure anchored to the pot of FIG. 1 in an inverted position.

### DESCRIPTION OF THE PREFERRED ACCOMPLISHMENT OF THE INVENTION

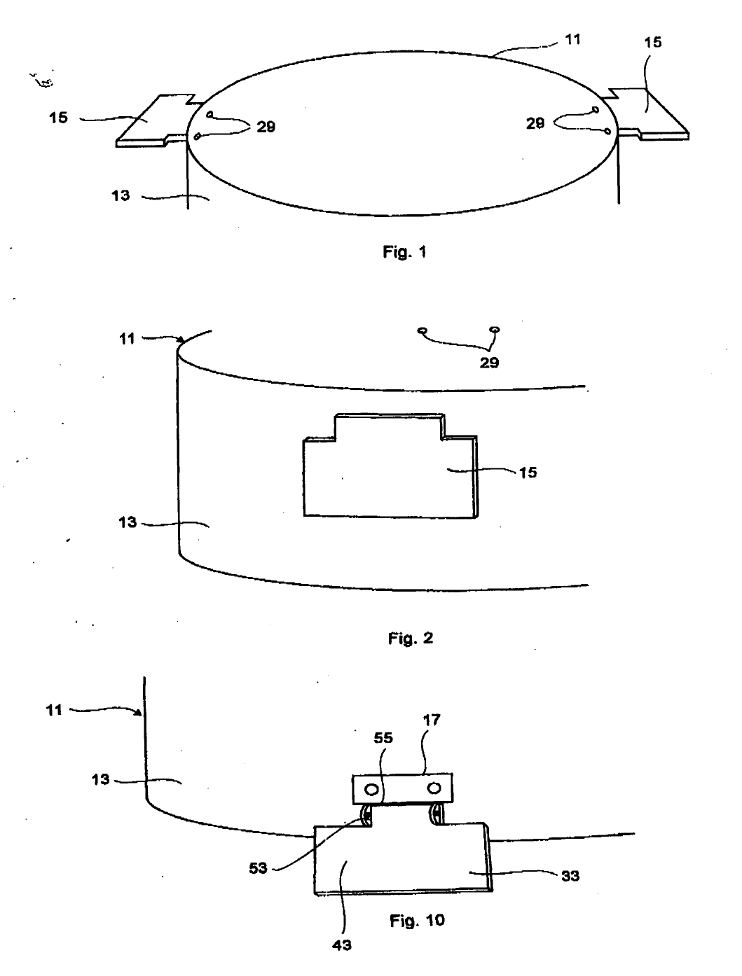

The pot illustrated in FIGS. 1 and 2 is a typical container 11 whose interior is destined to contain foods for preparing, cooking or baking and on whose exterior sides 13, are a pair of handles 15 which are arranged everlasting and completely opposed, according to the invention.

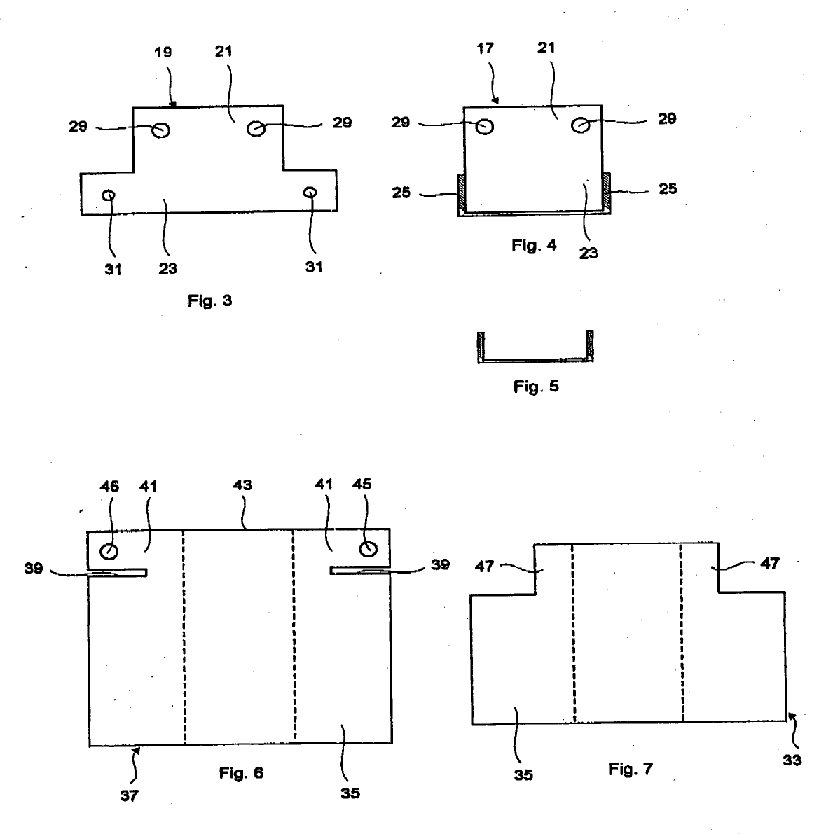

The construction of each of the handles 15 includes two parts, one of which is the anchorage piece 17 which can be obtained from a plate 19 illustrated in FIG. 3.The plate 19 is obtained from a metal sheet trimmed in form of T in order to present a portion of the core 21 of 25 mm×15 mm and a portion of the wings 23 of 45 mm×8 mm. Two folds at 90° are practiced in the wings 23 in order to form two ears 25, as shown in the finished piece 17 of FIGS. 4 and 5. Previously two drills 27 are practiced on the portion of core 21 in order to pass the rivets 29 to anchor the piece 17 to the wall 13 of the pot and another pair of holes 31 foreseen for the ears 25 for the joint. The second piece which conforms the handle 15 is a foldable piece 33 which conforms the handle 35 itself, the part of the pot held physically with the fingers. The foldable piece 33 can be obtained from a rectangular metal sheet 37 of 45 mm×55 mm where two narrow openings 39 of 2 mm width and 10 mm length are cut in the illustrated way as shown in FIG. 6 to define a pair of wings 41 of 8 mm width bound to the main portion 25 of piece 33, to which a metal hoop 43 of 40 mm×20 mm leans Both wings 41 are drilled to practice holes 45 for the joint and then folded at 90° to form the respective ears 47 as shown in FIG. 7.

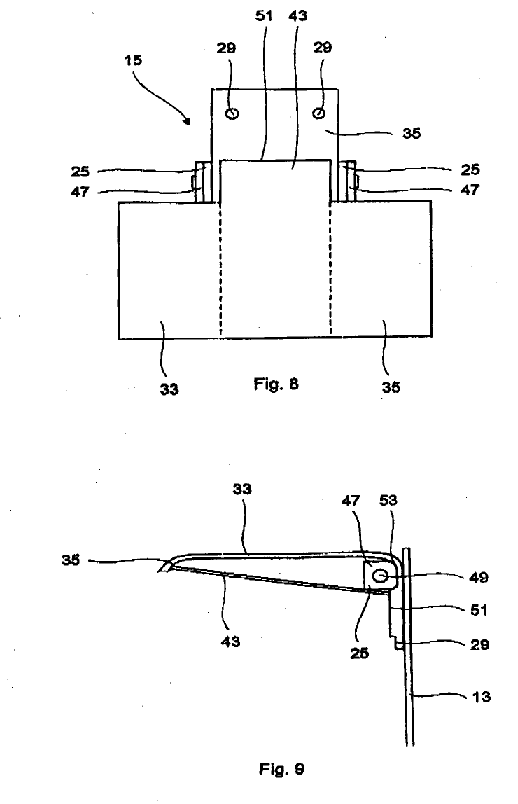

FIGS. 8 and 9 show how the foldable piece 33 is assembled to the anchored piece 1.7 for which the holes 45 of piece 33 coincide with the holes 31 of the anchored piece 17 where a bolt 49 is passed or rivets in order to make the joint which permits to stretch out the handle 15 from storing position (FIG. 2) to using position (FIG. 9) which is supported thanks to the free rim 51 of the metal hoop rim 43 which blocks against a step 52 defined by a convexity on the surface of the anchored piece 17. On the other side, the internal rim 53 of the foldable piece makes a butt against the opposite upper rim 55 of the anchored piece 17, as can be appreciated in FIG. 10, which permits to lift the container 11.

To store the pot, it is enough to push the metal hoop 43 slightly upwards and let the foldable piece 33 fall to the sides of the container 11.

All the pieces 17;33;43 are made of stainless steel plate AISI 304, of 1 mm thickness except the metal hoop 43 which is 0.5 mm thick. The latter one should have certain flexibility and elasticity while the main pieces 17;33 have to be substantially rigid. An explanation of the accomplishment of the invention has been described, anticipating that the experts in this matter might eventually think in changes and variations of the described form without changing the spirit and the scope of the invention. For example, the faculty of the metal hoop to block the foldable piece 33 in the position of use, can be carried out by means of a spring or any other suitable elastic medium.

1. A household pan with handles, of the type of a casserole in particular, which includes a suitable recipient to contain foods in its interior for preparing, cooking or baking and at least one handle attached on the external side of this recipient, characterized because the mentioned handle includes a piece for anchorage, fixed to the said external side of the recipient jointed with a foldable piece in a position of use and a position of storage, including the mentioned foldable piece a plate consisting of a main part that can be taken hold, which remains spread out essentially transverse to the said side of the recipient in the said position of use and folded essentially against the said side of the recipient in storing position, and a security device able to stop the turn of the said foldable piece regardless of the said position of use.

2. A household pan with handles according to the claim 1, characterized because the said piece to be anchored has at least one ear projected in an essentially perpendicular plane to the referred side while the said foldable piece has at least one ear projected in an essentially transverse plane to the referred main part that can be taken hold, being the respective ears of both pieces linked by a joint so that the folding piece can be articulated between the said position of use and the said position of storage.

3. A household pan with handles according to claim 2, characterized because those pieces are obtained from metal sheets and the mentioned ears are formed by folding those metal sheets.

4. A household pan with handles according to claims 2 or 3, characterized because the mentioned security device is formed between the respective rims brought face to face.

5. A household pan according to the claims 2;3 or 4, characterized because the said articulation includes a bolt put through the holes practiced in the said ears.

6. A household pan with handles according to any of the preceding claims, characterized because the said security device includes a metal hoop, relatively flexible, joined to the free end of the main part that can be taken hold and which presents a free rim that blocks, in the said position of use, against a convexity formed in the said piece of anchorage.

7. A household pan with handles according with any of the preceding claims, characterized because it also includes an elastic mean which is able to request the said foldable piece to its use position.

8. A household pan with handles according to any of the preceding claims, characterized because it also includes an elastic mean which is able to request the said foldable piece to its storage position.

9. A household pan with handles according to any of the preceding claims, characterized because the said piece for anchorage is riveted to the said external side of the recipient.

10. A household pan with handles according to any of the preceding claims, characterized for displaying two of the said handles diametrically opposed in the said recipient.
